(19) United States
(12) Patent Application Publication
(10) Pub. No.: US 2010/0164679 A1
(43) Pub. Date: Jul. 1, 2010

(54) INTEGRATED CIRCUIT INCLUDING A FUSING CIRCUIT CAPABLE FOR PROTECTING A FUSING SPARK

(76) Inventors: Sung-Min Park, Nowon-gu (KR); Seok-Hoon Bang, Yongin-si (KR)

Correspondence Address: SHERR & VAUGHN, PLLC, 620 HERNDON PARKWAY, SUITE 320, HERNDON, VA, 20170, US

(21) Appl. No.: 12/643,020

(22) Filed: Dec. 21, 2009

(30) Foreign Application Priority Data
Dec. 30, 2008 (KR) 10-2008-0137602

(51) Int. Cl. H01H 85/04

(52) U.S. Cl. 337/297

(57) ABSTRACT

An integrated circuit includes a first inner circuit including at least one first semiconductor device, a second inner circuit including at least one second semiconductor device, and a fusing circuit connected between the first inner circuit and the second inner circuit to perform a fusing operation which electrically disconnects the first inner circuit from the second inner circuit through a fusing voltage. The fusing circuit bypasses a spark current occurring during the fusing operation to a ground power source so as not to flow the spark current into the first inner circuit and the second inner circuit.

The present application claims priority under 35 U.S.C. §119 to Korean Patent Application No.10-2008-0137602 (filed on Dec. 30, 2008), which is hereby incorporated by reference in its entirety.

### BACKGROUND

With the development of the semiconductor industry, an integrated circuit (IC) has been miniaturized and its performance has been enhanced. However, the manufacturing cost of the IC occupies a considerable part of its development cost. Moreover, performance of the IC may be deteriorated by various factors such as a process error during a process of manufacturing the IC.

Unlike a hybrid circuit, once the IC is manufactured, since it is difficult to alter or repair the IC, the IC of which performance is deteriorated should be newly manufactured. For this reason, the manufacturing cost of the IC increases. In this respect, it is general that a designer of the IC designs an IC to include a dummy circuit or a fusing resistor therein, and partially repairs, tests, or tunes the manufactured IC using the dummy circuit or the fusing resistor.

FIG. 1 is a brief block diagram illustrating an IC 100 that includes a fuse. As illustrated in FIG. 1, the IC 100 includes an upper inner circuit 110, a fuse 120, a lower inner circuit 130, a first fusing pad 142, and a second fusing pad 144. For resistor distribution, etc. inside the IC 100, the fuse 120 is connected between the upper inner circuit 110 and the lower inner circuit 130. One end of the fuse 120 is connected to the first fusing pad 142, and the other end of the fuse 120 is connected to the second fusing pad 144.

If adjustment is needed for the IC 100, a first voltage Vf1 is applied to the first fusing pad 142, and a second voltage Vf2 (Vf2<Vf1) is simultaneously applied to the second fusing pad 144, such that the fuse 120 is blown out. At this time, since the first voltage Vf1 and the second voltage Vf2 for blowing out the fuse 120 are simultaneously applied to the first fusing pad 142 and the second fusing pad 144, respectively, an undesired spark current Isp may occur. Since the second voltage Vf2 is a ground voltage, the lower inner circuit 130 may be less damaged but the upper inner circuit 100 may be damaged as it is affected directly by the spark current Isp. This damage could lead to deterioration of yield and productivity during mass production of the IC.

### SUMMARY

Embodiments relate to a semiconductor device, and more particularly, to an integrated circuit including a fusing circuit for preventing a fusing spark occurring during a fusing operation.

Embodiments relate to an integrated circuit including a fusing circuit for protecting an integrated circuit from a spark current occurring during a fusing operation.

In accordance with embodiments, an integrated circuit can include at least one of the following: a first inner circuit including at least one first semiconductor device; a second inner circuit including at least one second semiconductor device; and a fusing circuit connected between the first inner circuit and the second inner circuit which performs a fusing operation to electrically disconnect the first inner circuit from the second inner circuit through a fusing voltage such that the fusing circuit bypasses a spark current occurring during the fusing operation to a ground power source so as not to flow the spark current into the first inner circuit and the second inner circuit. The integrated circuit in accordance with embodiments may also include a trimming circuit of which performance is controlled by the fusing operation, including at least one third semiconductor device.

In accordance with embodiments, an integrated circuit can include at least one of the following: a first inner circuit including a first semiconductor device; a second inner circuit including a second semiconductor device; a fusing circuit connected between the first inner circuit and the second inner circuit to perform a fusing operation which electrically disconnects the first inner circuit from the second inner circuit through a fusing voltage, the fusing circuit bypassing a spark current that occurs during the fusing operation to a ground power source; and a trimming circuit controlled by the fusing operation, the trimming circuit including a third semiconductor device.

Accordingly, the integrated circuit in accordance with embodiments has the following advantages. As a spark current occurring during the fusing operation is guided to the ground power source and voltage drop is guided by the spark current, the spark current is prevented from flowing into the inner circuit or the spark voltage is prevented from being applied to the inner circuit, such that the integrated circuit can be protected.

### DRAWINGS

FIG. 1 illustrates a IC having a fuse.

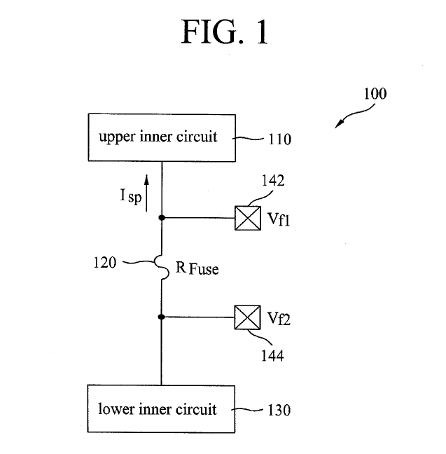

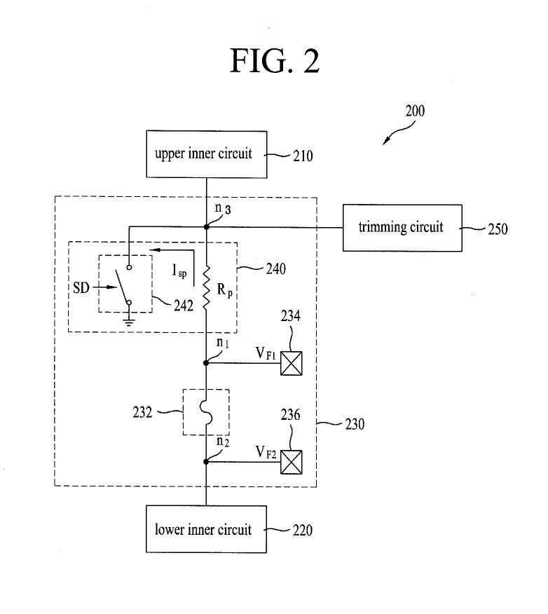

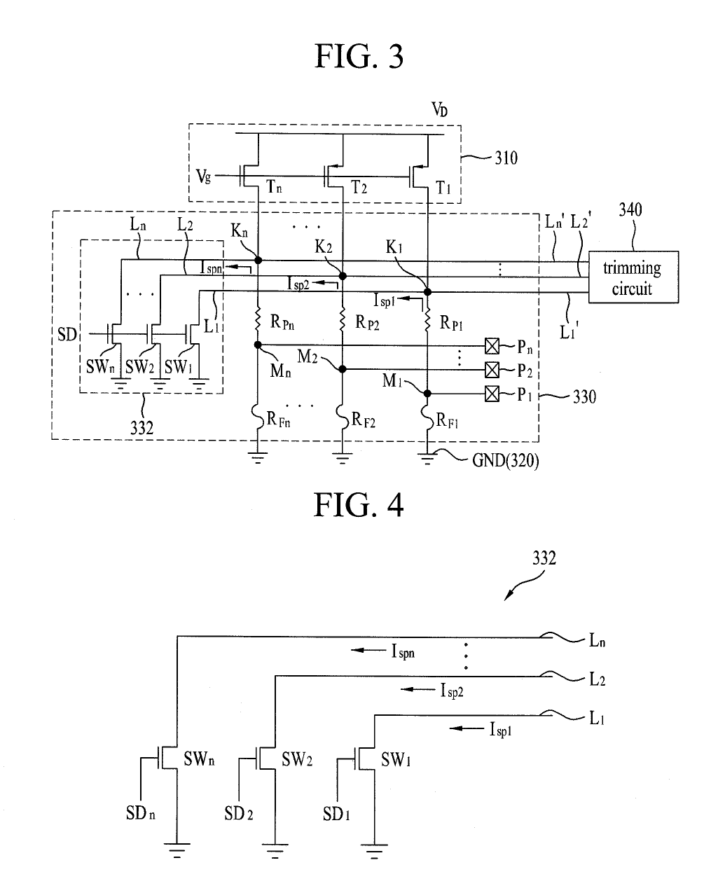

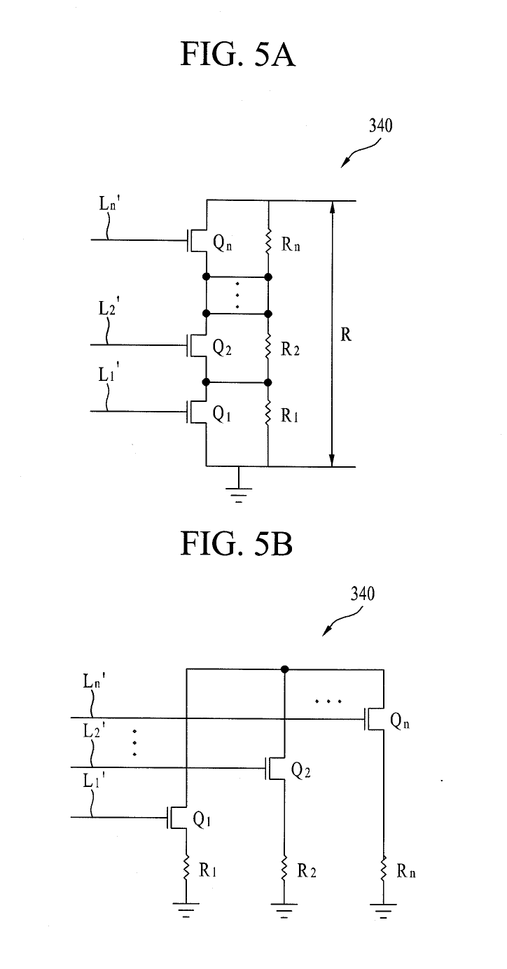

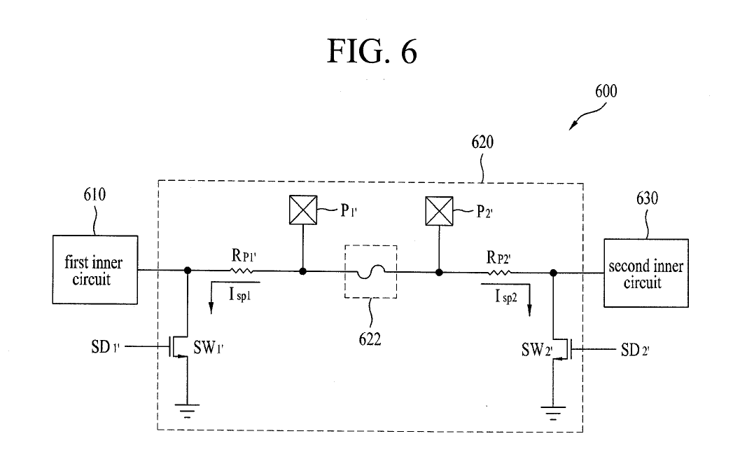

Example FIGS. 2 to 6 illustrates an integrated circuit having a fusing circuit for preventing a fusing spark, in accordance with embodiments.

### DESCRIPTION

Reference will now be made in detail to the preferred embodiments of the present invention, examples of which are illustrated in the accompanying drawings. Wherever possible, the same reference numbers will be used throughout the drawings to refer to the same or like parts.

Example FIG. 2 illustrates a view of an integrated circuit 200 that includes a fusing circuit for preventing a fusing spark, in accordance with embodiments. As illustrated in example FIG. 2, the integrated circuit 200 includes an upper inner circuit 210, a lower inner circuit 220, a fusing circuit 230, and a trimming circuit 240. The fusing circuit 230 is connected between the upper inner circuit 210 and the lower inner circuit 220. For example, the lower inner circuit 220 could be a ground power source. The trimming circuit 240 is connected to the fusing circuit 230, and its performance is adjusted by operation of the fusing circuit 230.

The fusing circuit 230 includes a fuse 232, a first fusing pad 234, a second fusing pad 236, and a protective circuit 240. The fusing circuit 230 performs the fusing operation to adjust performance of the trimming circuit 240. In this case, the fusing operation means that a first voltage V_{F1} is applied to the first fusing pad 234 and a second voltage V_{F2} is applied to the second fusing pad 236 to blow out the fuse 232. At this time, the first fusing voltage V_{F1} and the second voltage V_{F2} are applied in a sufficient range to blow out the fuse 230 by considering the capacity of the fuse 230. One end of the fuse 232 is connected with the first fusing pad 234 at a connection point such as a first node n1. The other end of the fuse 232 is connected with the second fusing pad 236 at a second node n2. The lower inner circuit 220 is connected to the second node n2 so that it is connected to the other end of the fuse 232.

The protective circuit 240 is connected between the one end n1 of the fuse 232 and the upper inner circuit 210, and bypasses the spark current Isp which occurs during the fusing operation, to the ground power source. The protective circuit 240 prevents the upper inner circuit 210 and the trimming circuit 250 from being damaged by the spark current Isp by bypassing the spark current Isp occurring during the fusing operation. The protective circuit 240 includes a protective resistor Rp and a protective switch 242. The protective resistor Rp is connected between the one end of the fuse 232 and the upper inner circuit 210 at a connection point such as a third node n3. Namely, the protective circuit Rp is connected between the first node n1 and the third node n3. The upper inner circuit 210 and the trimming circuit 250 are connected to the third node n3.

The protective circuit 242 is connected between the third node n3 and the ground power source. The protective circuit 242 is turned on or off by a switching control signal SD, and is controlled to be in a turn-on state previously before the fusing operation. For example, before the first fusing voltage V_{F1} and the second fusing voltage V_{F2} are respectively applied to the first fusing pad 234 and the second fusing pad 236, the protective switch 242 is turned on in response to the switching control signal SD.

A power voltage is only applied to the integrated circuit 200 before the fusing operation, and the integrated circuit 200 is disabled by a disable signal. Since the integrated circuit is disabled, it does not perform normal operation but shorts the third node n3 to the ground power source by turning on the protective switch 242 only through the switching control signal SD. At this time, the disable signal could be the switching control signal SD.

After the protective switch 242 is turned on, if the first fusing voltage V_{F1} is applied to the first fusing pad 234 and the second fusing voltage V_{F2} is applied to the second fusing pad 236, the fuse 232 is blown out and at the same time the spark current Isp occurs simultaneously. The simultaneously generated spark current Isp flows to the ground power source through the protective resistor Rp and the protective switch 242 but hardly flows to the upper inner circuit 210 and the trimming circuit 250. At this time, the protective resistor Rp guides voltage drop through the spark current Isp to prevent the first node n1 and the third node n3 from being shorted, such that the upper inner circuit is protected from the spark current Isp and the spark voltage.

Example FIG. 3 illustrates a view of an integrated circuit 300 in accordance with embodiments that includes a fusing circuit for preventing a fusing spark. As illustrated in example FIG. 3, the integrated circuit 300 includes an upper inner circuit 310, a ground power source GND 320, a fusing circuit 330, and a trimming circuit 340.

The upper inner circuit 310 includes a plurality of transistors T1 to Tn (n is a natural number greater than 1 n>1). The fusing circuit 330 includes a plurality of fuses RF1 to RFn, a plurality of protective resistors Rp1 to Rpn, a plurality of fusing pads P1 to Pn, and a switch part having a plurality of switches SW1 to SWn. One end of each of the plurality of fuses RF1 to RFn is connected to the ground power source GND 320, and the other end M1 to Mn of each of the plurality of fuses RF1 to RFn is connected one end of any corresponding one of the plurality of protective resistors Rp1 to Rpn. For example, one end of the first fuse RF1 is connected to the ground power source GND, and the other end M1 of the first fuse RF1 is connected to one end of the first protective resistor Rp1.

Each of the plurality of fusing pads P1 to Pn is connected to the other end of any corresponding one of the plurality of fuses RF1 to RFn. For example, the first fusing pad P1 can be connected to the other end M1 of the first fuse RF1. Each of the plurality of switches SW1 to SWn is connected between the other end (any one of K1 to Kn) of any corresponding one of the plurality of protective resistors RF1 to RFn and the ground power source 320, and is switched in response to the switching control signal. For example, the first switch SW1 can be connected between the other end K1 of the first protective resistor RF1 and the ground power source 320. Each of the plurality of transistors T1 to Tn includes a gate to which a gate voltage Vg is applied, and is connected between the other end (any one of K1 to Kn) of any one of the plurality of protective resistors RF1 to RFn and an inner power voltage VD.

The trimming circuit 340 is connected to the other end (K1 to Kn) of each of the plurality of protective resistors RF1 to RFn through a plurality of lines L1 to Ln. The inner power voltage VD is only applied to the integrated circuit 300 before the fusing operation, and the integrated circuit 300 is disabled by a disable signal (not shown). The plurality of switches SW1 to SWn are turned on in response to the switching control signal so that the other end (K1 to Kn) of the plurality of protective resistors RF1 to RFn are shorted to the ground power source GND. At this time, the switching control signal SD could be the disable signal.

After the plurality of switches SW1 to SWn are turned on, a fuse voltage is applied to at least one of the plurality of fusing pads P1 to Pn. The fuse connected to the fusing pad to which the fuse voltage is applied may be blown out, such that a spark current (at least one of Isp1 to Ispn) may occur simultaneously. The simultaneously generated spark current is guided to the ground power source 320 through at least corresponding one of the plurality of protective resistors RF1 to RFn and at least corresponding one of the plurality of switches SW1 to SWn. For example, the first spark current Isp1 flows to the ground power source through the first protective resistor Rp1 and the first switch SW1. The at least one spark current (at least one of Isp1 to Ispn) hardly flows to any corresponding one of the plurality of transistors T1 to Tn and the trimming circuit 350, such that the upper inner circuit 310 and the trimming circuit 340 can be protected from the spark current.

Example FIG. 4 illustrates a diagram of the switch part 332 illustrated in example FIG. 3. Example FIG. 4, the switch part 332 includes a plurality of switches SW1 to SWn. Each of the plurality of switches SW1 to SWn is connected between the other end (any one of K1 to Kn) of any one of the plurality of protective resistors RF1 to RFn and the ground power source 320. However, unlike example FIG. 3, the plurality of switches SW1 to SWn are respectively turned off in response to any corresponding one of a plurality of switching control signals SD1 to SDn.

Therefore, the switch corresponding to one of the plurality of fuses RF1 to RFn, which is intended to be blown out, can only be turned on during the fusing operation. For example, to perform the fusing operation of the first fuse RF1, the first switch SW1 is only turned on by the first switching control signal and then the fusing voltage is applied to the first fusing pad P1. In accordance with embodiments illustrated in example FIG. 4, power consumption can be reduced as compared with embodiments illustrated in example FIG. 3.

Example FIG. 5A illustrates a diagram of a trimming circuit illustrated in example FIG. 3, and example FIG. 5B illustrates a diagram of a trimming circuit illustrated in example FIG. 3. As illustrated in example FIG. 5A, the trimming circuit 340 includes a plurality of trimming resistors R1 to Rn and a plurality of trimming switches Q1 to Qn. The plurality of trimming resistors R1 to Rn are connected with one another in series. Each of the plurality of trimming switches Q1 to Qn includes a gate connected to the other end of any corresponding one of the plurality of protective resistors RF1 to RFn, and is connected with both ends of any corresponding one of the plurality of resistors R1 to Rn. The plurality of trimming switches Q1 to Qn are all turned on during normal operation of the integrated circuit, such that a resistor R of the trimming circuit becomes zero (0) so as not to affect the integrated circuit. However, if the fusing operation is performed for the first fuse RF1, the voltage of the other end of the first protective resistor RF1 is dropped to the ground power source GND. As a result, the first trimming switch Q1 is turned off, such that the resistor R of the trimming circuit 340 becomes a first trimming circuit R1 and performance of the integrated circuit can be trimmed. As illustrated in example FIG. 5B, the plurality of trimming resistors R1 to Rn are connected with one another in parallel through the plurality of trimming switches Q1 to Qn.

Example FIG. 6 illustrates an integrated circuit 600 that includes a fusing circuit for preventing a fusing spark, in accordance with embodiments. As illustrated in example FIG. 6, the integrated circuit 600 includes a first inner circuit 610, a fusing circuit 620, and a second inner circuit 630. The fusing circuit 620 includes a first switch SW1′, a first protective resistor RP1′, a first fusing pad P1′, a fuse 622, a second protective resistor Rp2′, and a second switch SW2′.

The first fusing pad P1′ is connected one end of the fuse 622, and the first fusing voltage is applied to the first fusing pad P1′ during the fusing operation. The second fusing pad P2′ is connected the other end of the fuse 622, and the second fusing voltage is applied to the second fusing pad P2′ during the fusing operation. The first protective resistor Rp1′ is connected between one end of the fuse 622 and the first inner circuit 610. Namely, one end of the first protective resistor Rp1′ is connected to one end of the fuse 622, and the other end of the first protective resistor Rp1′ is connected to the first inner circuit 610. The second protective resistor Rp2′ is connected between the other end of the fuse 622 and the second inner circuit 620. Namely, one end of the second protective resistor Rp2′ is connected to the other end of the fuse 622, and the other end of the second protective resistor Rp2′ is connected to the second inner circuit 620. The first switch SW1′ is turned on or off by a first control signal SDP, and is connected between the other end of the first protective resistor Rp1′ and the ground power source. The second switch SW2′ is turned on or off by a second control signal SD2′, and is connected between the other end of the second protective resistor Rp2′ and the ground power source.

A power voltage is only applied to the integrated circuit 600 before the fusing operation, and the integrated circuit 600 is disabled by a disable signal. Since the integrated circuit is disabled, it does not perform normal operation but the first switch SW1′ and the second switch SW2′ are turned on by the first control signal SD1′ and the second control signal SD2′, such that the other end of the first protective resistor Rp1′ and the other end of the second protective resistor Rp2′ are shorted to the ground power source. At this time, the disable signal can be used as the first control signal SD1′ and the second control signal SD2′.

Next, if the fusing voltage is applied to the first fusing pad P1′ and the second fusing pad P2′ during the fusing operation, the fuse 622 is blown out and at the same time spark currents Isp1′ and Isp2′ occur simultaneously. The simultaneously generated spark currents Isp1′ and Isp2′ are guided to the ground power source through a first switch SDP and a second switch SD2′. At this time, the spark currents Isp1′ and Isp2′ hardly flow to the first inner circuit 610 and the second inner circuit 630, such that the first inner circuit 610 and the second inner circuit 630 can be protected.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus comprising:
a first inner circuit including at least one first semiconductor device;
a second inner circuit including at least one second semiconductor device; and
a fusing circuit connected between the first inner circuit and the second inner circuit to perform a fusing operation which electrically disconnects the first inner circuit from the second inner circuit through a fusing voltage,
wherein the fusing circuit bypasses a spark current occurring during the fusing operation to a ground power source so as not to flow the spark current into the first inner circuit and the second inner circuit.

2. The apparatus of claim 1, further comprising a trimming circuit whose performance is controlled by the fusing operation.

3. The apparatus of claim 2, wherein the trimming circuit includes at least one third semiconductor device.

4. The apparatus of claim 1, wherein the apparatus comprises an integrated circuit.

5. The apparatus of claim 4, wherein the integrated circuit is disabled during the fusing operation.

6. The apparatus of claim 1, wherein the fusing circuit comprises:
a first fusing pad to which a first fusing voltage is applied;
a second fusing pad to which a second fusing voltage is applied;
a fuse having one end connected to the first fusing pad at a first node and another end connected to the second fusing pad at a second node, the fuse being electrically blown out by the first fusing voltage and the second fusing voltage applied during the fusing operation; and
a protective circuit which bypasses a spark current that occurs during the fusing operation to a ground power source so as not to flow the spark current into the first inner circuit and the second inner circuit.

7. The apparatus of claim 6, wherein the protective circuit comprises:
a first protective resistor having one end connected to the first node and another end connected to the first inner circuit at a third node; and
a first protective switch connected between the third node and the ground power source, the first protective switch bypassing a spark current to the ground power source.

8. The apparatus of claim 7, wherein the spark current is turned on before the fusing operation and flowing to the first protective resistor during the fusing operation.

9. The apparatus of claim 8, wherein the protective circuit further comprises:
a second protective resistor having one end connected to the second node and another end connected to the second inner circuit at a fourth node; and
a second protective switch connected between the fourth node and the ground power source, the second protective switch bypassing a spark current to the ground power source.

10. The apparatus of claim 9, wherein the spark current is turned on before the fusing operation, flowing to the second protective resistor during the fusing operation.

11. The apparatus of claim 10, wherein the first protective switch and the second protective switch are turned on in response to a disable signal of the integrated circuit before the fusing operation.

12. The apparatus of claim 11, wherein the first protective switch and the second protective switch are turned on before the first fusing voltage is applied to the first fusing pad and the second fusing voltage is applied to the second fusing pad.

13. The apparatus of claim 1, wherein the first inner circuit includes a plurality of transistors and the second inner circuit is a ground power source.

14. The apparatus of claim 13, wherein the fusing circuit includes a plurality of fuses, a plurality of fusing pads, a plurality of protective resistors, and a plurality of switches.

15. The apparatus of claim 14, wherein each of the plurality of fusing pads is connected to the another end of any corresponding one of the plurality of fuses and the fusing voltage is applied to at least one of the fusing pads during the fusing operation.

16. The apparatus of claim 15, wherein one end of each of the plurality of fuses is connected to the ground power source, the another end of each of the plurality of fuses is connected to one end of any corresponding one of the plurality of protective resistors, and each of the plurality of fuses is electrically connected by the fusing voltage.

17. The apparatus of claim 16, wherein each of the plurality of switches is connected between the another end of any corresponding one of the plurality of protective resistors and the ground power source and turned on before the fusing operation to bypass the spark current to the ground power source during the fusing operation.

18. The apparatus of claim 17, wherein each of the plurality of transistors is connected between the another end of any corresponding one of the plurality of protective resistors and an inner power voltage.

19. The apparatus of claim 18, wherein the plurality of switches are respectively controlled to turn on a switch only corresponding to one of the plurality of fuses, which is intended to be blown out, during the fusing operation.

20. An apparatus comprising:
a first inner circuit including a first semiconductor device;
a second inner circuit including a second semiconductor device;
a fusing circuit connected between the first inner circuit and the second inner circuit to perform a fusing operation which electrically disconnects the first inner circuit from the second inner circuit through a fusing voltage, wherein the fusing circuit bypasses a spark current that occurs during the fusing operation to a ground power source; and
a trimming circuit controlled by the fusing operation, the trimming circuit including a third semiconductor device.
